(19) United States
(12) Patent Application Publication
(10) Pub. No.: US 2011/0317890 A1
(43) Pub. Date: Dec. 29, 2011

(54) SYSTEM AND METHOD FOR ADVANCED SCANNING AND FOR DEFORMATION SIMULATION OF SURFACES

(75) Inventors: Guido Baroni, Monza (IT); Marco Riboldi, Monza (IT); Paolo Patete, Paderno Dugnano (IT)

(73) Assignee: POLITECNICO DI MILANO, Milano (IT)

(21) Appl. No.: 13/141,679

(22) PCT Filed: Dec. 22, 2009
(86) PCT No.: PCT/IB09/08022

§ 371 Date: Sep. 12, 2011

(30) Foreign Application Priority Data
Dec. 24, 2008 (IT) VI2008A000309

(51) Int. Cl. G06K 9/00

(52) U.S. Cl. 382/128; 382/154

(57) ABSTRACT

A system and method for advanced scanning and for simulation of the deformation of surfaces are particularly advantageous for the application of three-dimensional scanning in the medical field. The system and the method allow obtaining digital models of surfaces characterized by an elevated signal-to-noise ratio and by the absence of artefacts due to the movements of the subject during the timing of the scanning. In particular, therefore, the method and system allow obtaining digital models of the surface of particular anatomical areas adapted for the pre-surgery planning, for the estimation and the evaluation of the surgical outcome and for the simulation of the deformation of the bodily surfaces due to predetermined movements performed by the subject.

### FIELD OF THE PRESENT INVENTION

The present invention relates to the field of three-dimensional scanning. In particular, the present invention relates to a system and a method for the advanced scanning of surfaces and for the simulation of the dynamic deformation of surfaces. Still more in particular, the present invention relates to a system and a method particularly appropriate for scanning and simulating the deformation of anatomical surfaces.

### STATE OF THE ART

Three dimensional scanning of an object consists in the analysis of the shape and the dimensions of the object in order to obtain a three dimensional digital model of the object to be used for several kinds of applications. Three dimensional scanning typically comprises two phases: the detection phase and the reconstruction phase. In the detection phase, an apparatus for three-dimensional scanning of surfaces is employed in order to obtain the so-called point cloud of the object, i.e. a discrete set of points that define the surface of the object. Said points are characterized by the corresponding coordinates in the three-dimensional space, for example by the Cartesian coordinates (X, Y, Z), but also by other kinds of coordinates such as spherical coordinates or cylindrical coordinates. In the reconstruction phase, a data processor is employed in order to extrapolate the shape of the object using the points of the point cloud (and their coordinates) detected in the previous phase by means of a reconstruction process wherein adjacent points are connected in order to obtain a continuous surface. For this purpose, there are several types of algorithms employing several mathematical procedures of optimization in order to reconstruct a digital model of the surface of the object starting from the discrete points detected.

The detection phase may be performed in several ways distinguishing the kind of scanning performed as contact scanning or non-contact scanning. In the contact scanning, the apparatus for the three-dimensional scanning of surfaces detects the point cloud of the object by means of the physical contact between a probe and the object itself. This kind of scanning, although very precise, presents several drawbacks such as the long duration of the scanning process and the risk of damaging the object to be investigated during the scanning in case of frail materials or to alter the detection in case of flexible materials.

On the contrary, non-contact scanning is based on the detection of radiation (light radiation, X-rays, ultrasounds) and allows therefore the detection of the point cloud of the object without physical contact between the scanner and the object itself. It is possible to distinguish between non-contact active scanning and non-contact passive scanning. In the non-contact active scanning, the apparatus for the three-dimensional scanning of surfaces emits a radiation and detects the radiation subsequently reflected by the object. In the non-contact passive scanning, the apparatus for the three-dimensional scanning of surfaces does not emit and kind of radiation, but it simply detects the environmental radiation (typically visible or infrared light) reflected by the object.

Particularly important in the field of non-contact three-dimensional active scanning are the laser scanners, in particular the laser scanner TOF (time-of-flight) and the triangulation laser scanner. In the laser scanner TOF, the coordinates of the points of the point cloud are determined by the apparatus for the three-dimensional scanning of surfaces on the basis of the time employed by a laser pulse emitted to be subsequently reflected and finally detected by the apparatus for the three dimensional scanning of surfaces itself. Knowing the speed of light c and measuring the time t employed by the laser light itself to travel the path scanner-point of the surface-scanner, it is possible to easily determine the distance and therefore the coordinates of the point of the surface with respect to the laser. Accordingly, the precision with which the coordinates of the points of the point cloud are measured with the laser scanner TOF is strictly connected with the precision with which the time t is measured.

On the contrary, triangulation laser scanners allow for the determination of the coordinates of the point of the point cloud only by means of geometric considerations. In particular, according to the triangulation principle, a triangle is univocally determined once one of the sides and the two adjacent angles are known. In the case of triangulation laser scanners, the triangle is formed by the emission point of the laser, the point to be detected on the surface of the object and the incidence point wherein the laser ray reflected by the object is detected by the scanner. Once the emission angle of the laser, the incidence angle of the reflected ray and the distance between the emission point and the incidence point are known, it is possible to easily determine the distance between the emission point and the point to be detected on the surface of the object and, therefore, the coordinates of same.

Three dimensional scanning is employed in several fields such as industrial fields, with the qualitative analysis of the surfaces of materials produced, the analysis of prototypes or the back engineering, the field of entertainment, with the creation of extremely realistic cartoons and video games, the architectural engineering field with the detailed analysis of urban spaces and even the archaeological field with the creation of virtual models of objects and buildings starting from the archaeological finds. However, one of the most recent and particularly important employment of three-dimensional scanning is the application in the medical field for the scanning of anatomical parts. Non-contact three-dimensional scanning is in fact a method completely non-invasive and it is particularly harmless and endurable for the patients. One of the examples of employment of three-dimensional scanning in the medical field concerns dentistry. In this case, three-dimensional scanning is employed, for example, in order to create digital models of dental structures in order to build partial dentures or to plan reconstructive or corrective treatments. A further example of three dimensional scanning in the medical field concerns plastic surgery, in particular facial surgery, aesthetic surgery and orthopedic surgery. Starting from an accurate three dimensional scanning of the body party involved (face, breasts, limbs, etc. . . . ) it is possible to obtain three-dimensional models of the body parts that can be employed either in the planning phase of the surgical intervention or in the phase of choice or design of a prosthesis. Three dimensional scanning of anatomical parts also plays an important role in the field of oncology wherein the detection of a precise and accurate model of the anatomical part at issue (for example, the breast), allows the planning of the radiotherapy treatment with extreme accuracy, concentrating the radiation with high precision only in the region of interest and avoiding, therefore, the overdosing of radiation.

In spite of the advantages and the development perspectives of the three-dimensional scanning in the medical field, the application of this technique to medicine is still characterized by a series of particularly relevant problems and drawbacks.

In order to obtain accurate and reliable models of anatomical parts for the planning of medical treatments, the scanning has to be extremely precise and the accuracy of the measurements must be extremely high (below 1 mm). In particular, one of the major problems concerning the three dimensional scanning of anatomical parts concerns the voluntary or involuntary movements of the patient during the time of scanning (for example, the respiratory movements). These movements produce digital models characterized by a low signal-to-noise ratio and by the presence of artifacts and deformations (such as a step-like deformation of the surface) rendering the models extremely inaccurate and unreliable. A method employed to avoid this problem is that of speeding up the scanning so as to reduce the time of scanning of the anatomical part. However, this solution is particularly inappropriate because it is possible to employ it only by means of static laser scanning that allows for the detection of the surface of interest only from one point of view, giving rise to incomplete models due to the presence of surface parts out of view. It is possible to solve this problem detecting the surface of interest from several points of view, but the fusion of the patches so detected is a computational problem which may lead to reconstruction mistakes to a relevant extent. On the other hand, the detection of the patient from several points of view implies the fact that the patient may modify its spatial position, thus adding further error sources to those already present in the patches fusion procedure. Further to the necessity of disposing of an instrument for the static 3D analysis of anatomical parts, in the last years the request for an instrument allowing for the simulation of the dynamic deformation of said anatomical parts has increased. The 4D analysis (3D+time) of the morphology of a determined part of the body would allow in fact for the simulation of its behavior when subject to several kinds of forces. In the specific case of the breast plastic surgery, the 4D morphologic analysis of the pectoral area would allow for the foreseeing and verification of the quality of the surgical result, both from a static point of view and from a dynamic point of view, for example during the execution of predefined bodily motions (running, moving of the arms, standing up from a chair, etc).

### SCOPE OF THE PRESENT INVENTION

In light of the problems concerning three dimensional scanning mentioned above, in particular as far as its application in the medical field is concerned, the scope of the present invention is that of providing a system and a method for the advanced scanning and the simulation of deformations of surfaces allowing for the overcoming of said problems.

In particular, scope of the present invention is that of providing a system and a method for the advanced scanning of surfaces which guarantee high accuracy and precision of the scanning. Still more in particular, scope of the present invention is that of providing a method and a system for the three dimensional scanning of surfaces allowing the compensation of random and physiological movements of the patient during the time of scanning and the provision of digital models of anatomical parts with a high signal-to-noise ratio. Scope of the present invention is that of introducing a system and a method allowing the compensation of the errors introduced, for example, by the breathing of the patient during the scanning. The present invention is directed to remove the artifacts present in the digital images of anatomical parts obtained by means of the three-dimensional scanning due to the movements of the patient during the scanning. Further scope of the present invention is that of providing a system and a method for the advanced scanning of surfaces allowing the easy elaboration of the data obtained performing three dimensional scanning of the object from several points of view or during different times or different experimental sessions. In particular, the present invention is directed to ease and improve the fusion of several surface patches obtained performing three dimensional scanning of the object. Still more in particular, the present invention is directed to avoid the patient positioning problems during three dimensional scanning performed at different times or during different experimental sessions. Moreover, the scope of the present invention is that of easing the comparison between the scanning of the same object, in particular of anatomical parts, performed at different times, for example before and after a specific treatment. Further scope of the present invention is that of providing a system and method for the simulation of the deformation of surfaces. In particular, scope of the present invention is that of providing a system and a method for simulating the dynamical deformations of surfaces during the execution of specific movements. Still more in particular, the present invention is directed to the acquisition by means of the three dimensional scanning of kinematical data to be employed as input for a simulation instrument of the dynamical deformations associated with the execution of specific motional and/or postural tasks. Further scope of the present invention is that of providing a system and a method allowing the provision of not only static morphological results but also the dynamic behaviors of specific anatomical parts further to specific surgical operations such as, for example, the insertion of prosthetic elements.

### SUMMARY OF THE INVENTION

The present invention relates to a system and a method for the advanced scanning and the simulation of the deformation of surfaces based on the three dimensional scanning of surfaces. The present invention is based on the general idea of determining a relative frame of reference rigidly bound to the subject and of determining the coordinates of the point cloud measured by means of the three dimensional scanning in said relative frame of reference. In particular, the present invention is based on the idea of providing the subject with markers and of localizing the subject itself by means of said markers and of devices for the acquisition of motion pictures simultaneously with the three dimensional scanning. In particular, the devices for the acquisition of motion pictures allow for the determination of a stationary absolute frame of reference inside which, by means of the markers applied to the subject, the relative frame of reference rigidly bound to the subject itself is determined. The determination of the transformations performed by the relative frame of reference during the timing of the three dimensional scanning allows the compensation of the involuntary movements of the subject during the time of scanning and the obtainment, therefore, of digital three dimensional models of surfaces characterized by a high signal-to-noise ratio. Moreover, according to a particularly advantageous embodiment of the present invention, the same approach is applied not only to the subject of the scanning, but also to the apparatus for the three dimensional scanning of surfaces so that said apparatus can be moved during the time of scanning thus allowing, for example, the obtainment of three dimensional scanning of surfaces from several points of view in a single measurement session.

According to a first embodiment of the present invention, a system for advanced scanning and for simulation of deformations of three dimensional surfaces is provided comprising an apparatus for three dimensional scanning of surfaces, devices for the acquisition of motion pictures of surface portions of the subject and markers adapted to be placed on the surface of the subject. The devices for the acquisition of motion pictures are fixed during the time of the three dimensional scanning and allow for the definition of a stationary absolute frame of reference. The markers to be placed on the surface of the subject allow for the definition of a relative moveable frame of reference rigidly bound to the subject itself. The system further comprises means for obtaining the coordinates of the points obtained by means of the apparatus for three dimensional scanning of surfaces in said relative frame of reference.

According to a particular advantageous embodiment of the present invention, the means for obtaining the coordinates of the points obtained by means of the apparatus for the three dimensional scanning of surfaces in the relative frame of reference rigidly bound to the subject comprise a central control unit conveniently configured. Examples of central control units suitable for the present invention may be data processors or computers provided by appropriate software.

According to a particular embodiment of the present invention, the apparatus for the three dimensional scanning of surfaces comprises a triangulation laser scanner or a laser scanner TOF.

According to a further embodiment of the present invention, the markers to be placed on the surface of the subject are active markers. Active markers comprise materials which emit radiation such as, for example, LED (light-emitting diodes).

According to a further embodiment of the present invention, the markers to be placed on the surface of the subject are passive markers, and the system further comprises means for the illumination of said markers. Passive markers comprise for example retroreflective materials. Illumination means for illuminating the passive markers may be manual and accordingly manually activable and de-activable, or automatic and accordingly automatically synchronized with the other devices of the system.

According to a particularly advantageous embodiment of the present invention, the system further comprises markers to be placed on the apparatus for the three dimensional scanning of surfaces. According to this embodiment of the present invention, the apparatus for the three dimensional scanning of surfaces is moveable during the time of scanning.

According to a particular embodiment of the present invention, a method for the advanced scanning of surfaces is provided comprising the following steps: application of markers in proximity to the surface or on the surface itself, three dimensional scanning of the surface, acquiring of motion pictures of said surface, said acquisition of motion pictures being simultaneous to said three dimensional scanning, determination of a stationary absolute frame of reference rigidly bound to the devices for the acquisition of motion pictures, determination of a relative frame of reference rigidly bound to said surface, determination of the coordinates of the points obtained by means of the three dimensional scanning in the relative frame of reference.

According to a further embodiment of the present invention, the method for the advanced scanning of surfaces comprises the following steps: determination of the mathematical transformation (T₁) correlating the position and the orientation of the relative frame of reference at each measuring instant (tₘ) with the position and the orientation of said relative frame of reference at a measuring instant (tᵣ) being taken as a reference instant: determination of the coordinates of the point obtained by means of the three dimensional scanning of surfaces in the relative frame of reference on the basis of the mathematical transformation (T₁).

According to a further embodiment of the present invention, the method for the advanced scanning of surfaces comprises the following steps: determination of the mathematical transformation (T₁) correlating the position and the orientation of the relative frame of reference at each measuring instant (tₘ) with the position and the orientation of the relative frame of reference at the measuring instant (tᵣ) being taken as a reference instant; determination of the mathematical transformation (T₂) that describes the position and the orientation of the apparatus for three dimensional scanning of surfaces at each measuring instant (tm); determination of the coordinates of the points measured by means of the three dimensional scanning of surfaces in the relative frame of reference on the basis of the mathematical transformations (T₁) and (T₂). Examples of mathematical transformations suitable for the present invention are translations, rotations, and roto-translations.

According to a particular embodiment of the present invention, a method for the simulation of the deformation of surfaces is provided comprising the following steps:
application of markers in proximity to the surface or on the surface
localization of said markers during the execution of specific movement protocols of said surface
determination of the displacements of said markers for each frame acquired during the acquisition of said movement protocols.

According to a particular advantageous embodiment of the present invention, a method for the simulation of the deformation of surfaces is provided further comprising the following steps:
determination of a three dimensional digital model of said surface by means of the advanced scanning of surfaces
generation of a dynamic model of said surface on the basis of said three-dimensional digital model by means of parameters representative of the dynamic behavior of the volume comprised by said surface
application frame-by-frame of said displacement to points identified on the digital model of the surface previously acquired and propagation of the displacements to the adjacent points of the surface

### BRIEF DESCRIPTION OF THE FIGURES

FIG. 1 schematically displays an example of a system with a fixed scanner for the advanced scanning of surfaces according to the present invention.

FIG. 2 schematically displays an example of a triangulation laser apparatus for three-dimensional scanning of surfaces with a fixed scanner.

FIG. 3 schematically displays an example of a system with a movable scanner for the advanced scanning of surfaces according to the present invention.

FIG. 4 schematically displays an example of a triangulation laser apparatus provided with markers for the three-dimensional scanning of surfaces with a movable scanner.

FIG. 5 displays an example of the disposition of markers on the surface of a subject according to the present invention.

FIG. 6 displays a determination of an absolute frame of reference and of a relative frame of reference rigidly bound to the subject according to an exemplary method of realisation of the present invention.

FIG. 7 schematically displays the way of operating of the system with a fixed scanner shown in FIG. 1.

FIG. 8 schematically displays the way of operating the system with a movable scanner shown in FIG. 3.

FIG. 9 displays the Cartesian coordinates of two points of a subject in a relative frame of reference rigidly bound to the subject itself.

FIG. 10 displays the result of an advanced scanning of an anatomical surface performed with a system and a method according to the present invention.

FIG. 11 displays the result of a simulation of the deformation of an anatomical surface performed with a system and a method according to the present invention.

In the enclosed drawings, identical or corresponding parts are identified by the same reference numbers.

### DETAILED DESCRIPTION OF THE INVENTION

In the following, the present invention is described with reference to particular embodiments as shown in the enclosed drawings. Nevertheless, the present invention is not limited to the embodiments described in the following detailed description and displayed in the figures, but rather, the embodiments described simply exemplify various aspects of the present invention, the scope of which is defined by the claims.

Further modifications and variations of the present invention will be clear for the person skilled in the art. The present description has to be accordingly considered as comprising all said modifications and/or variations of the present invention the scope of which is defined by the claims.

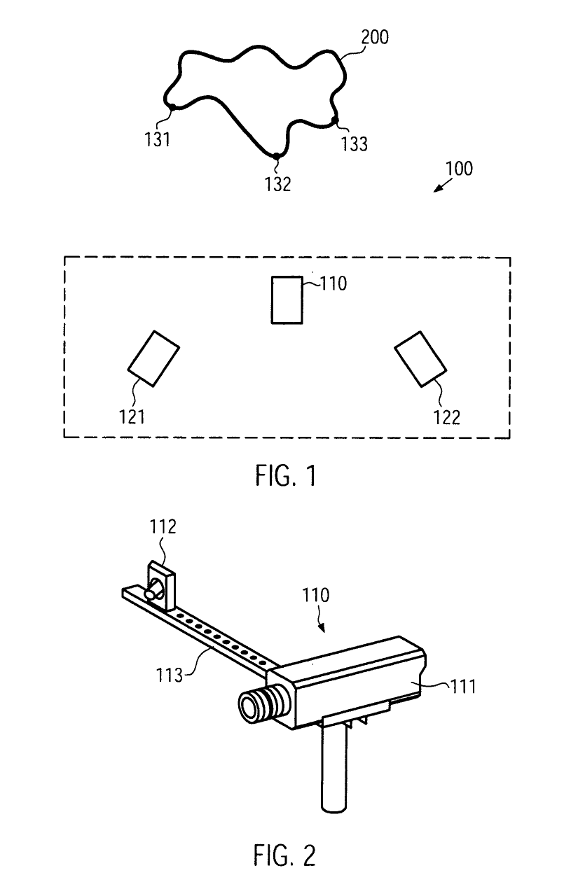

A first embodiment of a system for advanced scanning and simulation of deformation of surfaces according to the present invention is shown in FIG. 1. The system 100 comprises an apparatus 110 for three-dimensional scanning of surfaces. The apparatus 110 is employed for the three-dimensional scanning of at least a portion of the surface of the subject 200. Examples of apparatuses for three-dimensional scanning of surfaces suitable for the present invention are, triangulation laser scanners, laser scanner TOF (time-of-flight), and other kinds of three-dimensional scanners. Particularly suitable for the application of the system according to the present invention in the medical field, are non contact three-dimensional scanners both because the non-contact three-dimensional scanning is a method completely non-invasive and accordingly, particularly harmless and endurable for the patients, and because contact three-dimensional scanning could imply the altered detection of the shapes and dimensions of anatomical parts comprising elastic tissues. The system 100 further comprises two devices 121, 122 for the acquisition of motion pictures. The devices 121, 122 for the acquisition of motion pictures are employed for the localization of the subject 200 and are rigidly bound to each other. Moreover, according to the embodiment of the present invention shown in FIG. 1, the devices 121, 122 for the acquisition of motion pictures are further rigidly bound to the apparatus 110 for three-dimensional scanning of surfaces. The devices 121, 122 for the acquisition of motion pictures may be rigidly bound to the apparatus 110 for three-dimensional scanning of surfaces, for example, by means of fastening means. Alternatively, both the devices 121, 122 for the acquisition of motion pictures and the apparatus 120 for the three-dimensional scanning of surfaces may be simply fastened to or leaning on, for example, the floor of a laboratory and are accordingly rigidly bound to each other and to the laboratory itself. The devices 121, 122 for the acquisition of motion pictures and the apparatus 110 for the three-dimensional scanning of surfaces are fixed during the timing of advanced scanning of surfaces. The dashed line shown in FIG. 1 encloses the elements of the system 100 which are rigidly bound to each other and which are fixed during the timing of the advanced scanning of surfaces.

The devices 121, 122 for the acquisition of motion pictures may comprise, for example, optoelectronic video cameras and may be provided with a CCD sensor with a resolution of at least 256×256 pixels. The number of devices for the acquisition of motion pictures employed may vary starting from a minimum number of two.

The system 100 shown in FIG. 1 further comprises three or more markers 131, 132, 133 placed on the surface of the subject 200. The markers employed in the present invention may be either active markers or passive markers. Active markers comprise materials emitting radiations such as, for example, LED (light emitting diode), in particular, infrared LED or visible light LED. Passive markers comprise retro-reflective materials and may be illuminated by appropriate illumination means. A particular example of passive markers is represented by plastic spheres or plastic semi-spheres having a diameter equal to or higher than 3 mm covered by retro-reflective materials. Illumination means for illuminating the passive markers may be manual, activable and de-activable manually, or automatic, activable and de-activable automatically according to the execution of the scanning procedures and, consequently, appropriately connected with the system 100, for example, by means of a central controller of the scanning procedures. The illuminating means to illuminate the passive markers may be coupled to the devices 121, 122 for the acquisition of motion pictures so as to synchronize the illumination of the markers with the acquisition of motion pictures of the subject 200.

An example of an apparatus 110 for three-dimensional scanning of surfaces comprising a triangulation laser scanner adapted for the embodiment of the present invention shown in FIG. 1 is schematically shown in FIG. 2. The apparatus 110 comprises a laser projector 112 and a video camera 111 for the detection of the radiation reflected by the subject. According to the position of the incident point of the radiation reflected by the subject within the visual field of the video camera, it is possible to determine the position of the points of the subject to be detected employing the triangulation principle and it is possible to obtain the point cloud representing the surface of the subject. The laser projector 112 and the video camera 111 are connected by support means 113. The support means 113 may be made, for example, by aluminium.

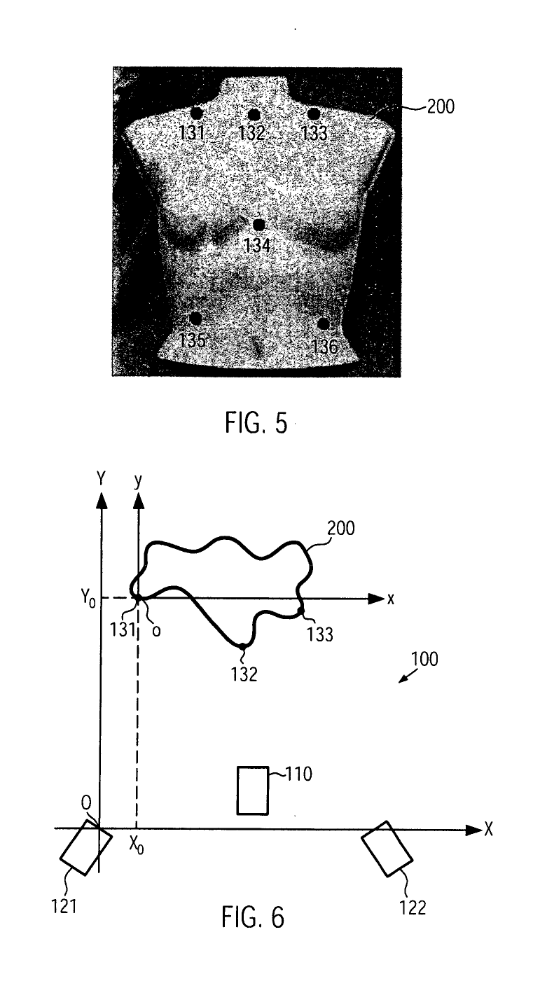

The method of operating the system schematically shown in FIGS. 1 and 2 is described in detail in the following with reference to FIGS. 5, 6, 7 and 9 wherein identical or corresponding parts are identified by the same reference numbers.

The first step of the method for the advanced scanning of surfaces with a fixed scanner consists in the application of markers on the subject. The markers applied on the subject may be applied both in proximity of the surface of interest and on the surface of interest itself. In case, for instance, of application of the present invention in the medical field, an in particular for the advanced scanning of the breast, the markers may be applied on the surface of the breast itself or on the chest in proximity of the breast. The application of six markers 131, 132, 133, 134, 135, 136 on the surface of a subject 200 comprising an anthropomorphic dummy is shown in FIG. 5.

Subsequently, the three-dimensional scanning of the surface and the localization of the markers are simultaneously performed.

The synchronization between the three-dimensional scanning of the surface and the localization of the markers allows the definition at each frame of the advanced scanning of a frame of reference rigidly bound to the subject in which the point detected by means of the three-dimensional scanning may be expressed. This is performed in the following way. An absolute frame of reference rigidly bound to the devices for the acquisition of motion pictures is established. For example, the origin of the absolute frame of reference may correspond to one of the devices for the acquisition of motion pictures. Since the devices for the acquisition of motion pictures are rigidly bound to the apparatus for three-dimensional scanning of surfaces, the absolute frame of reference is rigidly bound to the apparatus for three-dimensional scanning of surfaces too. A relative frame of reference is determined inside the absolute frame of reference, in particular, a relative frame of reference rigidly bound to the subject is determined. The determination of the relative frame of reference rigidly bound to the subject is based on the localization of the markers applied on the subject itself inside the absolute frame of reference. For example, the origin of the relative frame of reference rigidly bound to the subject may correspond to one of the markers applied to the subject.

These procedures are schematically shown in FIG. 6. For simplicity, FIG. 6 displays a bi-dimensional system. The third dimension is perpendicular to the plane of the figure and, for simplicity, is omitted from the following detailed description. FIG. 6 displays a system 100 for advanced scanning and the simulation of the deformation of surfaces similar to the system shown in FIG. 1. In the example shown in FIG. 6, an absolute frame of reference (X-Y) is determined whose origin (O) coincides with a point of the device for the acquisition of motion pictures 121. Alternatively, the origin (O) of the absolute frame of reference (X-Y) may coincide with one point of the device for the acquisition of motion pictures 122 or with a point of the apparatus 110 for the three-dimensional scanning of surfaces. In general, the origin (O) of the absolute frame of reference (X-Y) may coincide with any point of the space rigidly bound to the devices 121, 122 for the acquisition of motion pictures. Once the origin (O) and the Cartesian axes X and Y of the absolute frame of reference (X-Y) are fixed, the Cartesian coordinate of both the devices 121 and 122 for the acquisition of motion pictures and of the apparatus 110 for the three-dimensional scanning of surfaces are determined. Furthermore, a relative frame of reference (x-y) is determined inside the absolute frame of reference (X-Y). The relative frame of reference (x-y) is a local frame of reference rigidly bound to the subject 200. In particular, in the example shown in FIG. 6, the origin (o) of the relative frame of reference (x-y) coincides with the position of the marker 131 applied to the subject 200 and the Cartesian axes (axis x and axis y) of the relative frame of reference (x-y) are parallel to the Cartesian axes (axis X and axis Y) of the absolute frame of reference (X-Y). In general, the origin (o) of the local frame of reference (x-y) bound to the subject 200 may coincide with any point rigidly bound to the subject 200. The origin (o) of the relative frame of reference (x-y) corresponds to the point (X₀, Y₀) in the absolute frame of reference.

During the timing of the scanning or because of scanning performed several times or during several experimental sessions, the relative frame of reference evolves. In particular, during the timing of the scanning, the position and the orientation of the relative frame of reference with respect to the absolute frame of reference change. The relative frame of reference, in fact, evolves according to the evolution of the position of the markers applied to the subject inside the absolute frame of reference. In the exemplary case of application of the present invention in the medical field, the markers are applied on the surface of the body of a patient and accordingly, the position of the markers applied to the subject evolves according to the voluntary or involuntary movements of the patient itself. For example, the position of the markers applied to the subject evolves according to the respiratory movements of the patient. In another example, the position of the markers applied to the subject evolves according to the position of the patient in case the scanning is performed in different times or in different experimental sessions. In a further example, the position of the markers applied to the subject evolves inside the absolute frame of reference in case subsequent scanning is performed from different points of view.

During the first frame of the advanced scanning procedure the initial relative frame of reference is established. In particular, the initial position and orientation of the relative frame of reference is established. The relative frame of reference is determined afterwards for every frame of the advanced scanning procedure.

Comparing the position and orientation of the relative frame of reference in the absolute frame of reference in the frames of the scanning and, in particular, with respect to the first frame taken as a reference, it is possible to obtain the mathematical transformation T₁ that allows the correlation of the local frames of reference in the various frames.

For each frame, some of the points of the point cloud corresponding to the subject are measured by the apparatus for three-dimensional scanning of surfaces. This procedure allows the obtainment, for each frame, of the distances of the points of the point cloud from the apparatus for three-dimensional scanning of surfaces.

Known, for each frame, the position and orientation of the subject and, therefore, the position and orientation of the relative frame of reference rigidly bound to the subject and the distances of the points of the point cloud of the subject from the apparatus for the three-dimensional scanning of surfaces, it is possible to determine the relative coordinates of the point cloud of the subject in the relative frame of reference rigidly bound to the subject itself.

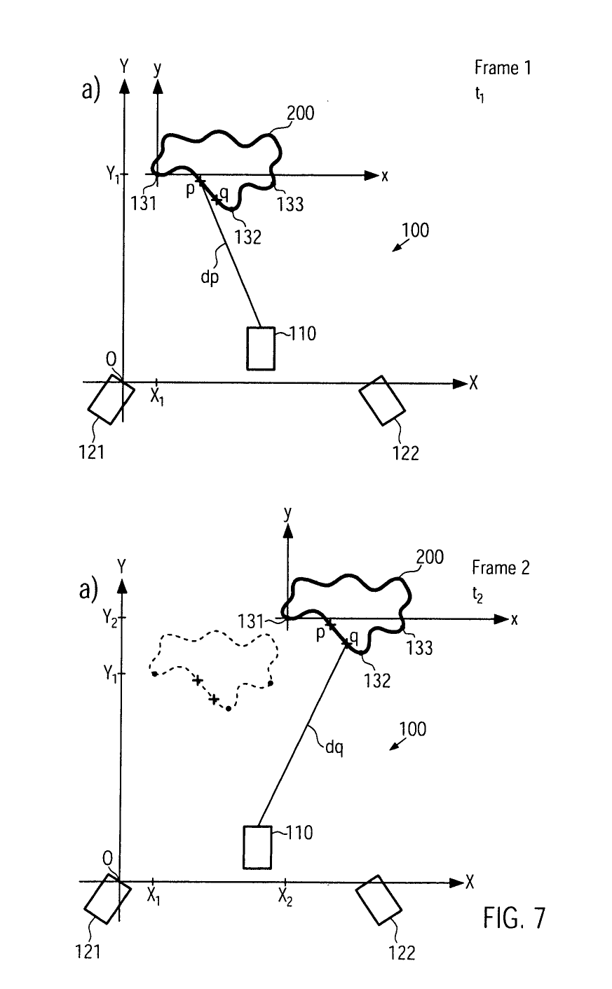

These procedures are schematically shown in FIG. 7. For simplicity, FIG. 7 displays a bi-dimensional system, the third dimension is perpendicular to the plane of the figure and, for simplicity, is omitted from the following detailed description. FIGS. 7a and 7b refer to two subsequent measuring instants t₁ and t₂ corresponding to the acquisition of the frames 1 and 2, respectively, of the advanced scanning. In both FIGS. 7a and 7b, a system 100 for the advanced scanning and simulation of the deformation of surfaces similar to the system shown in FIG. 1, is shown.

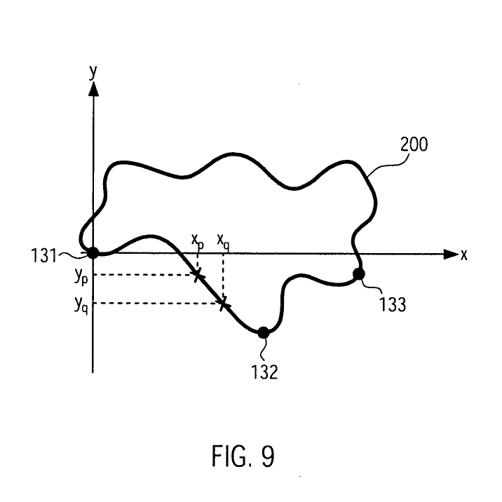

At the measuring instant t₁ (FIG. 7a), the frame 1 is acquired and, simultaneously, the apparatus 110 for the three-dimensional scanning of surfaces measures the distance d_{P} of the point P of the subject 200 from the apparatus 110 itself. At the instant t₁, the origin of the relative frame of reference (x-y) rigidly bound to the subject 200 coincides with the point having coordinate (X₁, Y₁) in the absolute frame of reference (X-Y) and the axes x and y of the relative frame of reference (x-y) are parallel to the axes X and Y of the absolute frame of reference (X-Y). Known, at the instant t₁, the distance d_{P} of the point P of the subject 200 from the apparatus 110, the position and orientation of the relative frame of reference (x-y) rigidly bound to the subject 200 and to the position and orientation of the apparatus 110, it is possible to determine the coordinates (x_{P}, y_{P}) of the point P in the relative frame of reference (x-y) rigidly bound to the subject (FIG. 9).

At the measuring instant t₂ (FIG. 7b), the frame 2 is acquired and, simultaneously, the apparatus 110 for the three-dimensional scanning of surfaces measures the distance d_{Q} of the point Q of the subject 200 from the apparatus 110 itself. Between the instant t₁ and the instant t₂, nevertheless, the subject 200 has possibly moved as shown in FIG. 7b. For this reason, the distance d_{Q} measured from the apparatus for the three-dimensional scanning at the instant t₂ comprises two contributions: a contribution due to the morphology of the surface of the subject 200 and a contribution due to the displacement of the subject itself. The contribution due to the displacement of the subject corresponds to a noise signal which does not contain any relevant information concerning the morphology of the surface of the subject 200. By means of the devices 121, 122 for the acquisition of motion pictures and of the markers 131, 132, 133 applied to the subject 200, it is possible to remove these noise contributions from the signal measured and to obtain therefore the information concerning the morphology of the surface of the subject 200. By means of the devices for the acquisition of motion pictures 121, 122 and of the markers 131, 132, 133, it is possible to determine the position and orientation of the relative frame of reference (x-y) rigidly bound to the subject 200 at the instant t₂ of the scanning. In the example shown in FIG. 7b, the origin of the relative frame of reference (x-y) corresponds to the point (X₂, Y₂) of the absolute frame of reference (X-Y) and the axes x and y of the relative frame of reference (x-y) are parallel to the axes X and Y of the absolute frame of reference (X-Y). Comparing, therefore, the positions and orientations of the relative frame of reference at the instants t₁ and t₂, it is possible to determine that the subject has performed a translation and that the translation vector has components (X₂-X₁) and (Y₂-Y₁). Known the distance d_{Q} measured at the instant t₂ by the apparatus 110 for the three-dimensional scanning of surfaces and the components of the translation vector describing the displacement of the subject between the instants t₁ and t₂, it is possible to obtain from d_{Q} the contribution due to the morphology of the surface of the subject. In particular, it is possible to obtain the coordinates (x_{Q}, y_{Q}) of the point Q in the relative frame of reference (x-y) rigidly bound to the subject 200 (FIG. 9). This procedure is repeated for all the points of the point cloud of the subject detected by the apparatus for the three-dimensional scanning of surfaces and for all the frames of the scanning. This allows the obtainment of the coordinates of all the points of the point cloud of the subject in the relative frame of reference (x-y) rigidly bound to the subject itself as schematically shown in FIG. 9 for the two points P and Q of the surface of the subject 200.

In the example described with reference to FIG. 7, the subject has performed a translation between the instants t₁ and t₂. Alternatively, the subject can perform, for instance, a rotation. Still more generally, the subject can perform a roto-translation. The kind of transformation T₁ and the parameters describing the transformation are determined comparing the position of the markers applied to the subject in the various frames of the scanning. The mathematical treatment of the transformation T₁ performed by the subject may be based on several methods of calculation. In a particular embodiment of the present invention, the mathematical treatment of the transformation performed by the subject is based on the matrix calculus.

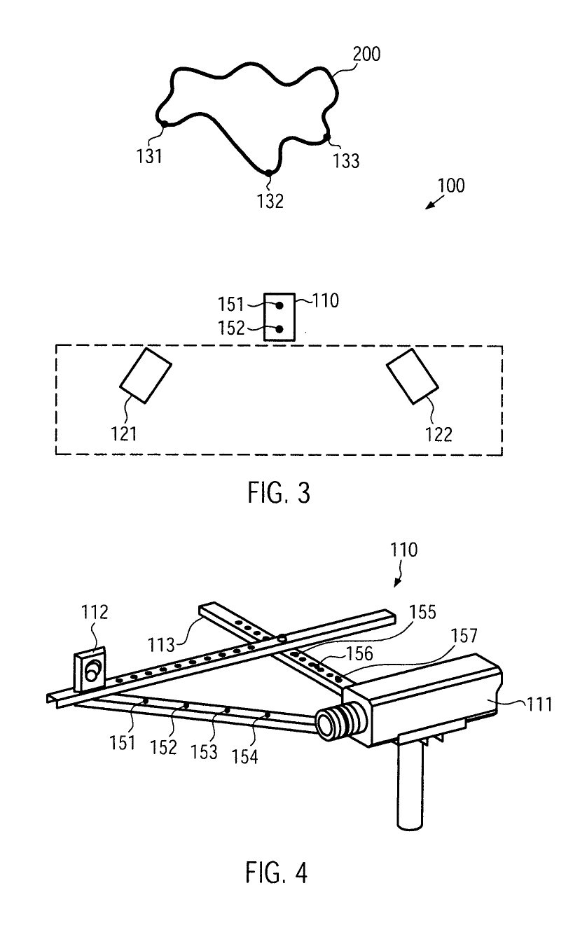

A further embodiment of the present invention is schematically shown in FIG. 3. In FIG. 3, the apparatus 110 for the three-dimensional scanning of surfaces is not rigidly bound to the devices 121, 122 for the acquisition of motion pictures. In particular, the apparatus 110 for the three-dimensional scanning of surfaces is movable during the timing of the advanced scanning of surfaces. The devices 121, 122 for the acquisition of motion pictures are rigidly bound to each other as shown in the figure by the dashed line and they are fixed during the time of the advanced scanning of surfaces. The devices for the acquisition of motion pictures 121, 122 may be rigidly bound to each other, for instance, by fastening means. Alternatively, the devices 121, 122 for the acquisition of motion pictures may be fixed to or simply lean on, for example, the floor of a laboratory and be accordingly rigidly bound to each other and to the laboratory itself.

The system 100 shown in FIG. 3 further comprises two markers 151, 152, placed on the apparatus 110 for the three-dimensional scanning of surfaces. The number of markers placed on the apparatus 110 for the three-dimensional scanning of surfaces may vary. In general, three or more markers are employed. Similar to the markers 131, 132, 133 placed on the surface of the subject 200, the markers 151, 152 placed on the apparatus 110 for the three-dimensional scanning of surfaces may be either active markers or passive markers. The markers 151, 152 placed on the apparatus 110 for the three-dimensional scanning of surfaces and the markers 131, 132, 133 placed on the surface of the subject 200 may be of the same type.

In FIG. 3, the devices 121, 122 for the acquisition of motion pictures are employed for the localization of the subject 200 and for the localization of the apparatus 110 for three-dimensional scanning of surfaces.

An example of an apparatus 110 for three-dimensional scanning of surfaces comprising a triangulation laser scanner adapted for the embodiment of the present invention shown in FIG. 3, is schematically shown in FIG. 4. The apparatus 110 comprises a laser projector 112 and a video camera 111 for the detection of the radiation reflected by the subject. The laser projector 112 and the video camera 111 are interconnected by support means 113. The apparatus 110 for the three-dimensional scanning of surfaces shown in FIG. 4 is further provided with markers 151, 152, 153, 154, 155, 156, 157 applied to the support means 113. Alternatively, the markers may also be applied to the laser projector 112 or to the video camera 111.

The method of operation of the system schematically shown in FIGS. 3 and 4 is described in detail in the following with reference to FIGS. 5, 6, 8 and 9 wherein identical or corresponding parts are identified by the same reference numbers.

The first step of the method for advanced scanning of surfaces with a movable scanner consists in the application of markers on the subject and on the apparatus for three-dimensional scanning of surfaces. The markers applied on the subject may be applied both in the proximity of the surface of interest and on the surface of interest itself. The application of six markers 131, 132, 133, 134, 135, 136 on the surface of the subject 200 comprising an anthropomorphic dummy is shown in FIG. 5. The markers applied on the apparatus for the three-dimensional scanning of surfaces may be applied, for example, to the support means of the apparatus for the three-dimensional scanning of surfaces as schematically shown in FIG. 4.

Subsequently, the three-dimensional scanning of surfaces and the localization of the markers are simultaneously performed. Both the markers applied on the surface of the subject and the markers applied on the apparatus for the three-dimensional scanning of surfaces are localized synchronously.

The synchronization between the three-dimensional scanning of surfaces and the localization of the markers allow the definition at each frame of the advanced scanning of a frame of reference rigidly bound to the subject in which the point of the point cloud measured with the three-dimensional scanning may be expressed. This is performed in the following way. An absolute frame of reference rigidly bound to the devices for the acquisition of motion pictures is established. Inside the absolute frame of reference, a relative frame of reference is determined. In particular, a local frame of reference rigidly bound to the subject is determined. The determination of the relative frame of reference rigidly bound to the subject is based on the localization of the markers applied to the subject itself inside the absolute frame of reference. For example, the origin of the relative frame of reference rigidly bound to the subject may coincide with one of the markers applied to the subject. This procedure is performed, for example, in a similar way to what is described above with reference to FIG. 6. In this case, however, since the apparatus 110 for the three-dimensional scanning of surfaces is movable during the scanning and is accordingly not rigidly bound to the devices 121, 122 for the acquisition of motion pictures, it is not possible to set the origin (O) of the absolute frame of reference in (X-Y) in one of the points of the apparatus 110 for the three-dimensional scanning of surfaces. The origin (O) of the absolute frame of reference (X-Y) may coincide with one of the points of the devices 121, 122 for the acquisition of motion pictures or, in general, with each point of the space rigidly bound to said devices 121, 122.

During the time of the scanning or because of scanning performed in different times or different experimental sections, the relative frame of reference evolves.

During the first frame of the advanced scanning procedure, the initial relative frame of reference is established. In particular, the initial position and orientation of the relative frame of reference are established. The relative frame of reference is, afterward, determined for each frame of the procedure of the advanced scanning.

Comparing the position of the relative frame of reference in the absolute frame of reference in each frame of the scanning and, in particular, with respect to the first frame taken as reference, it is possible to obtain the mathematical transformation T₁ that allows the correlation of the positions of the relative frames of reference in the various frames.

Moreover, during the time of the scanning, the apparatus for the three-dimensional scanning of surfaces is movable and can be moved. For each frame, the position of the markers applied to the apparatus for the three-dimensional scanning of surfaces inside the absolute frame of reference is determined. In particular, for each frame, the position of the apparatus for the three-dimensional scanning of surfaces inside the absolute frame of reference is determined. This allows the obtainment of the mathematical transformation T₂ describing the position and orientation of the apparatus for three-dimensional scanning of surfaces inside the absolute frame of reference.

For each frame, some of the points of the point cloud of the subject are measured from the apparatus for the three-dimensional scanning of surfaces. This allows obtaining for each frame the distances of the point of the point cloud from the apparatus for three-dimensional scanning of surfaces.

For each frame, are known: the position of the subject (and, accordingly, of the relative frame of reference rigidly bound to it) in the absolute frame of reference rigidly bound to the devices for the acquisition of motion pictures, the position of the apparatus for three-dimensional scanning of surfaces in the absolute frame of reference rigidly bound to the devices for the acquisition of motion pictures and the distances of the points of the point cloud of the subject measured by the apparatus for three-dimensional scanning of surfaces.

From these quantities, it is possible to obtain the coordinates of the points of the point cloud of the subject in the relative frame of reference rigidly bound to the subject itself.

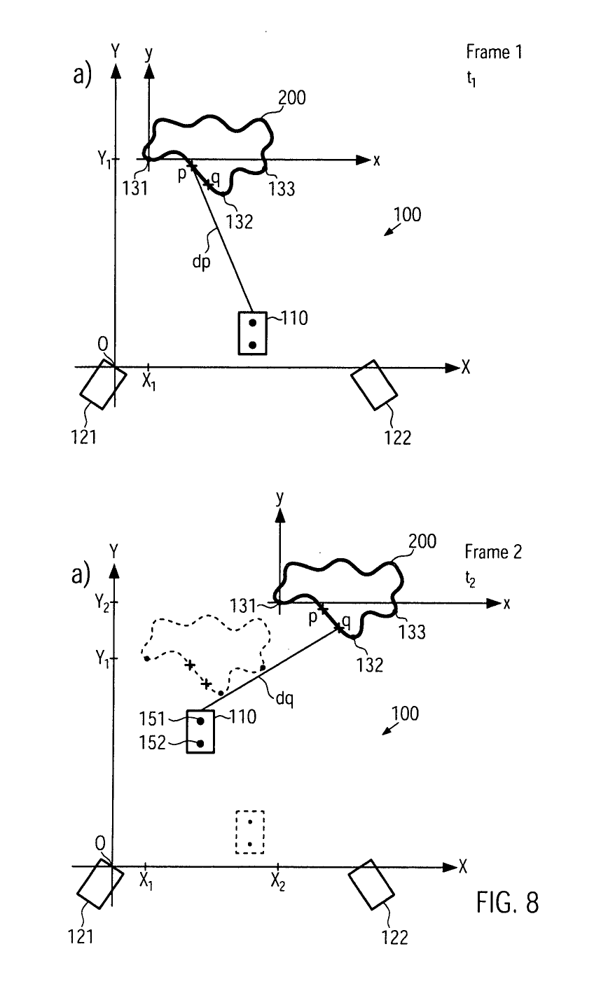

These procedures are schematically shown in FIG. 8. In FIG. 8, for simplicity, a bi-dimensional system is considered. The third dimension is perpendicular to the plane of the figure and, for simplicity it is omitted from the following detailed description. FIGS. 8a and 8b relates to two subsequent measuring instants t₁ and t₂ corresponding to the acquisition of the frames 1 and 2, respectively, of the advanced scanning. In both FIGS. 8a and 8b, a system 100 for advanced scanning and simulation of the deformation of surfaces similar to the system shown in FIG. 3 is shown.

At the measuring instant t₁ (FIG. 8a), the frame 1 is acquired and, simultaneously, the apparatus 110 for three-dimensional scanning of surfaces measures the distance d_{P} of the point P of the subject 200 from the apparatus 110 itself. At the instant t₁ the origin of the relative frame of reference (x-y) rigidly bound to the subject 200 coincides with the point (X₁, Y₁) of the absolute frame of reference (X-Y) and the axes x and y of the relative frame of reference (x, y) are parallel to the axes X and Y of the absolute frame of reference (X-Y). Known, at the instant t₁, the distance d_{P} of the point P of the subject 200 from the apparatus 110, the position and orientation of the relative frame of reference (x-y) rigidly bound to the subject 200 and the position and orientation of the apparatus 110, it is possible to determine the coordinates (X_{P}, Y_{P}) of the point P in the relative frame of reference (x-y) rigidly bound to the subject (FIG. 9). At the measuring instant t₂ (FIG. 8b) the frame 2 is acquired and, simultaneously, the apparatus 110 for three-dimensional scanning of surfaces measures the distance d₀ of the point Q of the subject 200 from the apparatus 110 itself. Nevertheless, between the instants t₁ and t₂, the subject 200 has possibly moved as shown in FIG. 8b. Moreover, between the instants t₁ and t₂, the apparatus 110 for three-dimensional scanning of surfaces also has been possibly moved as shown in FIG. 8b. For this reason, the distance d_{Q} measured by the apparatus for three-dimensional scanning at the instant t₂ comprises three contributions: a contribution due to the morphology of the surface of the subject 200, a contribution due to the displacement of the apparatus 110 for three-dimensional scanning and a contribution due to the displacement of the subject itself. The contributions due to the displacement of the subject and to the displacement of the apparatus 110 for the three-dimensional scanning of surfaces are known by means of the devices 121, 122 for the acquisition of motion pictures, of the markers 131, 132, 133, applied to the subject 200 and of the markers 151, 152, applied to the apparatus 110 for three-dimensional scanning of surfaces.

By means of the position of the markers 131, 132, 133, applied to the subject 200 measured by the devices 121, 122 for the acquisition of motion pictures, the position and orientation of the relative frame of reference (x-y) rigidly bound to the subject 200 at the instant t₂ are obtained. In FIG. 8b, the origin of the relative frame of reference (x-y) corresponds to the point (X₂, Y₂) of the absolute frame of reference (X-Y) and the axes x and y of the relative frame of reference (x-y) are parallel to the axes X and Y of the absolute frame of reference (X-Y). Comparing, therefore, the positions and orientations of the relative frame of reference at the instants t₁ and t₂, it is possible to determine that the subject has performed a translation and that the translation vector has components (X₂-X₁) and (Y₂-Y₁).

By means of the position of the markers 151, 152, applied to the apparatus 110, measured by the devices 121, 122 for the acquisition of motion pictures, the position and orientation of the apparatus 110 for three-dimensional scanning of surfaces in the absolute frame of reference at the instant t₂ is obtained. Known the distance d_{Q} measured at the instant t₂ by the apparatus 110 for three-dimensional scanning of surfaces, the components of the translation vector describing the displacement of the subject 200 between the instants t₁ and t₂ and the position and orientation of the apparatus 110 for three-dimensional scanning of surfaces in the absolute frame of reference at the instant t₂, the contribution due to the morphology of the subject 200 is obtained from d_{Q}. In particular, known the distance d_{Q} measured at the instant t₂ by the apparatus 110 for three-dimensional scanning of surfaces and known the positions and orientation of said apparatus 110 in the absolute frame of reference at the same instant t₂, the coordinates of the point Q in the absolute frame of reference at the instant t₂ are obtained. Known, therefore, the coordinates of the point Q in the absolute frame of reference at the instant t₂ and the components of the translation vector describing the displacement of the subject 200 between the instants t₁ and t₂, the coordinates (x_{Q}, y_{Q}) of the point Q in the relative frame of reference (x-y) rigidly bound to the subject 200 are obtained (FIG. 9). This procedure is repeated for each point of the point cloud of the subject measured by the apparatus for three-dimensional scanning of surfaces and for each frame of the scanning. This allows the obtainment of the coordinates of all the points of the point cloud of the subject in the relative frame of reference (x-y) rigidly bound to the subject itself as schematically shown in FIG. 9 for the two points P and Q of the surface of the subject 200.

In the example described with reference to FIG. 8, the subject has performed a translation between the instants t₁ and t₂. Alternatively, the subject may perform, for example, a rotation. Still more generally, the subject may perform a roto-translation. The kind of transformation and the parameters describing it are determined comparing the positions of the markers applied to the subject in the various frames of the scanning. Similarly, the apparatus for three-dimensional scanning of surfaces may perform several kinds of displacements such as translations, rotations and roto-translations.

The mathematical treatment of the transformations T₁ and T₂ performed, respectively, by the subject and by the apparatus for three-dimensional scanning of surfaces may be based on several calculus methods. In a particular embodiment of the present invention, the mathematical treatment of the transformation performed by the subject and by the apparatus for three-dimensional scanning of surfaces is based on matrix calculus.

In this embodiment of the present invention, the position of the apparatus for three-dimensional scanning of surfaces is measured in each frame of the scanning. This allows the apparatus for three-dimensional scanning of surfaces to be displaced during the scanning itself. In this way it is possible, for example, to perform the scanning of the subject from several points of view during a single measurement session. This allows, for instance, performing the scanning of the subject from several points of view without the need of repositioning the subject itself. On the contrary, the apparatus for three-dimensional scanning of surfaces is displaced and, simultaneously, its position is measured by means of the devices for the acquisition of motion pictures thanks to the markers applied thereto.

The result of the method for advanced scanning of surfaces according to the present invention and, in particular, the result of the methods according to particular embodiments of the present invention described above is the obtainment of the coordinates of the points of the point cloud of the surface of interest in the relative frame of reference rigidly bound to the subject as schematically shown in FIG. 9. In this way, the rigid component of the movements performed by the subject during the time of scanning is removed. In this way, for example, in case of medical application of the present invention, the involuntary movements of the patient during the time of scanning are removed. Moreover, the availability of the relative coordinates in the relative frame of reference rigidly bound to the subject of the points of the point cloud allow a quick and immediate registration in a single morphological model of portions of the surface measured in different times or in different experimental sessions. A fusion of several patches of surface is therefore extremely easy and immediate. Considering the relative frame of reference rigidly bound to the subject, it is accordingly possible to easily combine the results of scanning performed from several points of view. It is moreover possible to easily compare the results of scanning performed in several different times, for example, before and after a specific medical treatment.

Known the coordinates of the points of the point cloud of the subject in the relative frame of reference rigidly bound to the subject itself, it is possible to determine the mathematical three-dimensional model of the surface according to the reconstruction processes typical of the three-dimensional scanning. Adjacent points of the point cloud are connected so as to obtain a continuous surface by means of several optimization mathematical procedures. The mathematical models may be geometry-based or physics-based. In particular, it is possible to obtain finite element models, particle-based models, spline-based models and similar. The final result is the three-dimensional digital model of the surface.

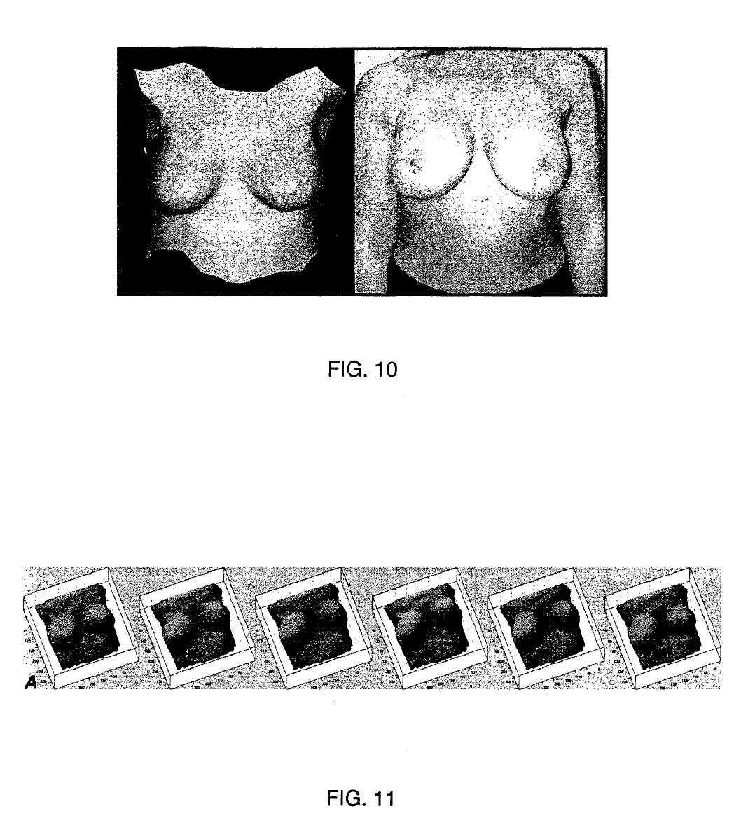

FIG. 10 displays the result of an advanced scanning of an anatomical surface performed with a system and a method according to the present invention. On the right, a photograph of the subject is shown, on the left, the corresponding three-dimensional digital model obtained with a system and a method for the advanced scanning of surfaces according to the present invention is shown. In particular, it is possible to observe that the three-dimensional digital model obtained with the advanced scanning does not display artefacts or noise signals due to involuntary movements of the patient during the scanning time. In the case shown in FIG. 10, a system for the advanced scanning of surfaces comprising a triangulation laser scanner and to opto-electronic video cameras provided with a CCD sensor with a resolution of 256×256 pixels has been employed. The acquisition frequency of the point cloud with the triangulation laser scanner and the acquisition frequency of the position of the subject with the video cameras correspond to 100 Herz.

In the following, a method for the simulation of the deformation of surfaces according to a particular embodiment of the present invention is described in detail.

The first step of the method for the simulation of the deformation of surfaces, comprises the application of markers on the subject. The markers may be applied both in proximity of the surface of interest and on the surface of interest itself. The number and position of the markers are specific for each kind of movement to be analyzed so as to find the correct compromise between the description of the movement and the complexity of the experimental set-up. The application of six markers 131, 132, 133, 134, 135, 136 on the surface of a subject 200 comprising an anthropomorphic dummy is shown exemplarily in FIG. 5. In general, the number of markers applied to perform the simulation of the deformation of surfaces may vary so that the movement of said markers can properly describe the movement of said surfaces. For instance, in the case of the simulation of the deformation of the surface of a breast following the movement of the arms, at least five markers are applied on the surface of the breast itself. Moreover, markers are applied in proximity of the breast, for instance, in the upper region of the chest and in the abdominal region.

Subsequently, the localization of said markers during the execution of specific movement protocols of the surface of interest is performed. Any movement may be selected, with the only requirement of keeping the markers visible in the visual field of the system for advanced scanning and the simulation of the deformation of surfaces during the entire execution of the movement. The localization of the markers may be performed, for instance, by means of devices for the acquisition of motion pictures. In particular, the localization of the markers may be performed by means of opto-electronic video cameras following an approach based on the optical tracking. The number of devices for the acquisition of motion pictures employed for the localization of markers may vary starting from at least two.

A mapping of the configuration of the markers for each frame of the registration of the movement is performed. In particular, the displacements of the markers are determined comparing their positions between the various frames of the registration of the movement.

The so determined displacements of the markers are applied to a digital three-dimensional model of the surface itself. In particular, the digital three-dimensional model of the surface may be obtained by means of the method for advanced scanning of surfaces according to the present invention. The digital three-dimensional models of the surfaces may be geometry-based or physics-based. In particular, it is possible to employ finite elements models, particle-based models, spline-based models and similar.

For the simulation of the deformation of surfaces according to the present invention, digital models whose parameters are representative of the dynamic behaviour of the volume comprised by the surface of interest may be employed. Said digital models are indicated as dynamic models. In particular, in case of applications of the present invention in the medical field, dynamic models whose parameters are representative of the dynamic behaviour of an anatomical part, such as the soft tissues, may be employed.

The displacement of the markers are applied to the three-dimensional dynamic model of the surface, frame by frame. In this case, for each of the frames, an iterative optimization process is performed so as to bring the entire model to a state of equilibrium before applying new displacements in the subsequent frame. The imposed deformation propagates through the entire three-dimensional model because of both mechanical forces (mechanical models) and geometrical displacements of the points of control of the surface (geometric models). In the particle-based models, for example, the displacement of markers imposed between the first and the second frame determines a variation (for instance, an extension or a compression) of the connections connecting the point of interest with its neighbours. The process continues until the entire surface reaches a state of equilibrium or until the maximum number of iterations imposed is reached. The application of the displacements of the subsequent frame follows in order to generate a new propagation of the deformations, and so on until the end of the dynamical acquisition.

A particular example of application of the method for the simulation of the deformation of surfaces according to the present invention concerns the medical field. In this case, the markers may be applied in correspondence to selected anatomical line marks and their localization may be performed during the execution of specific postural protocols and movement protocols of the patient. This can be performed to evaluate, for example, not only the morphological modification to which the body portion is subjected to following a particular medical treatment such as, for example, the implantation of a prosthesis, but also to foresee the dynamical behaviours of said portion after the treatment itself. In this case, for the provision of the surgical outcome, the same algorithm described above may be employed, with the expedient of introducing the effects of a possible prosthesis in the choice of the parameters representing the dynamic behaviour of the volume comprised by the surface of interest. The parameters employed, therefore, are not only representative of the dynamical behaviour of an anatomical part such as, for example, the soft tissues, but they are representative also of the presence of prostheses and/or implantations, for example, below the adipose tissue and the skin.

FIG. 11 displays the results of a method for the simulation of the deformation of surfaces according to a particular embodiment of the present invention to evaluate the effects of a reconstruction operation of the breast by means of the implantation of a prosthesis. In particular, six frames of the dynamic simulation of a lateral symmetric abduction of the arms of the subject from a rest position with the arms along the body (frame 1) to a complete lateral abduction with both arms elongated above the head (frames 3 and 4) and finally, the coming back to the starting position (frame 6) are shown. The scope is that of evaluating the effects of the reconstruction of the breast on the movements of the subject. In the sequence analyzed, the right breast of the patient has been rebuilt with a DIEP flap (Deep Inferior Epigastric Perforator). The effect of the reconstructed tissue is clearly visible in the simulation wherein the right breast raises less than the left breast.

The system for the advanced scanning and the simulation of the deformation of surfaces of the present invention may be provided with a central controller for the coordination of the operations of the components of the system itself. In particular embodiments of the present invention, the central controller for the coordination of the operations of the components of the system for the advanced scanning and the simulation of the deformation of surfaces may be provided with appropriate software. The central controller is configured to manage, for example, the operation of the apparatus for three-dimensional scanning of surfaces, the operation of the devices for the acquisition of motion pictures and the synchronization of the measuring operations. The controller may be furthermore configured to manage the illumination of the markers in case these are of the passive kind. Moreover, the controller may be configured to manage the storage of the data acquired and, in particular, to correlate the data measured at each measuring instant by means of the three-dimensional scanning of surfaces and the frames registered at the same instant by means of the devices for the acquisition of motion pictures. By means of an appropriate software, it is possible to perform the procedures according to the method for the advanced scanning and the simulation of the deformation of surfaces according to the present invention. In particular, the software allows the determination of an absolute frame of reference rigidly bound to the devices for the acquisition of motion pictures and of a relative frame of reference rigidly bound to the subject. The software allows following, frame by frame, the evolution of the relative frame of reference and it enables the determination of the geometrical transformations allowing the correlation between the position and the orientation of the relative frame of reference in each frame with the position and orientation of same in a frame taken as a reference frame. Moreover, in case of advanced scanning of surfaces with a moveable scanner, the software allows the determination of the geometrical transformation that correlates the position and orientation of the apparatus for three-dimensional scanning of surfaces at each frame with the position and orientation of same in a frame taken as reference. Known the transformations as stated above, the coordinates of the points measured by means of the three-dimensional scanning in the relative frame of reference are determined.

It has been shown that the system and method for advanced scanning and the simulation of the deformation of surfaces according to the present invention are particularly advantageous for the application of three-dimensional scanning in the medical field. The method and system of the present invention allow the obtainment of a 3D model of the surface of special anatomical areas adapted for the pre-surgical planning, for the estimation and for evaluation of the surgical outcome and for the simulation of the deformation of the body surface due to predetermined movements performed by the subject. In particular, the advantages in the specific case of morphological 4D modelling (3D+time) of the breast have been shown for the planning of the reconstruction surgery and for the subsequent post-surgery follow up of the patient. In particular, by means of the present invention, the plastic surgeon may associate to the static representation of the morphology of the body region of interest also the information concerning the dynamical behaviour of the same region during execution of specific movements. By means of the present invention, it is possible for example, to improve the static evaluation of the morphology of the breast following a reconstruction by means of implantation and to verify the surgical outcome even during the execution of most of the movements of the every day life wherein the patient has to reach a psychological level of confidence allowing the achievement of a quality of life to which she was used to before the mastectomy operation.

1. A system for advanced scanning and for simulation of deformations of tridimensional surfaces of a subject, comprising
a scanning apparatus for tridimensional scanning of surfaces,
devices for acquisition of motion pictures of surface portions of said subject, said devices being configured to define a stationary absolute frame of reference;
first markers configured to be placed on said subject so as to define a relative frame of reference rigidly bound to said subject; and
obtaining means for obtaining coordinates in said relative frame of reference of points measured by said scanning apparatus.

2. A system according to claim 1, wherein said obtaining means comprises a central control unit configured to:
control performing simultaneously said tridimensional scanning and said acquisition of motion pictures of surface portions of said subject; and
correlate points measured at respective measuring instants by said tridimensional scanning with reference frames registered at the respective measuring instants by said acquisition of motion pictures.

3. A system according to claim 2, wherein:
said central control unit is further configured to determine a mathematical transformation correlating a position and an orientation of said relative frame of reference at each measuring instant with a position and an orientation of said relative frame of reference at a reference instant of said measuring instants.

4. A system according to claim 3, wherein:
said central control unit is further configured to determine coordinates of the points measured by said scanning apparatus in said relative frame of reference based on said mathematical transformation.

5. A system according to claim 1, further comprising second markers configured to be placed on said scanning apparatus, wherein:
said scanning apparatus is movable during the tridimensional scanning; and
said devices for the acquisition of motion pictures of surface portions of said subject are further adapted to acquire motion pictures of said scanning apparatus.

6. A system according to claim 5, wherein said obtaining means comprises a central control unit configured to:
control performing simultaneously said tridimensional scanning, said acquisition of motion pictures of surface portions of said subject and an acquisition of motion pictures of said scanning apparatus; and
correlate points measured at respective measuring instants by said tridimensional scanning with frames registered at the respective measuring instants by said devices for the acquisition of motion pictures.

7. A system according to claim 6, wherein:
said central control unit is further configured to determine a mathematical transformation correlating a position and an orientation of said relative frame of reference at each measuring instant with a position and an orientation of said relative frame of reference at a reference instant of said measuring instants; and
said central control unit is further configured to determine a mathematical transformation that describes a position and an orientation of said scanning apparatus in said absolute frame of reference at each measuring instant.

8. A system according to claim 7, wherein:
said central control unit is further configured to determine coordinates of the points measured by said scanning apparatus in said relative frame of reference based on said mathematical transformations.

9. A system according to claim 1, wherein:
said first markers are active markers.

10. A system according to claim 1, wherein:
said first markers are passive markers and said system further comprises illumination means to illuminate said passive markers.

11. A system according to claim 5, wherein:
said second markers are active markers.

12. A system according to 5, wherein:
said second markers are passive markers and said system further comprises illumination means to illuminate said passive markers.

13. A system according to claim 1, wherein:
said scanning apparatus comprises a triangulation 3D laser scanner or a time-of-flight 3D laser scanner.

14. A method for advanced scanning of surfaces, comprising:
applying markers in proximity of a surface or on the surface;
tridimensionally scanning said surface;
acquiring motion pictures of portions of said surface, wherein acquiring motion pictures is simultaneous to tridimensional scanning said surface;
determining a stationary absolute frame of reference rigidly bound to devices for the acquiring of motion pictures;
determining a relative frame of reference rigidly bound to said surface; and
determining coordinates of points measured by said tridimensional scanning in said relative frame of reference.

15. A method according to claim 14 wherein determining the coordinates of the points measured by said tridimensional scanning in said relative frame of reference further comprises:
determining a mathematical transformation correlating a position and an orientation of said relative frame of reference at respective measuring instants with position and an orientation of said relative frame of reference at a reference instant of said measuring instants; and
determining coordinates of points measured by said tridimensional scanning of surfaces in said relative frame of reference based on said mathematical transformation.

16. A method according to claim 14, further comprising:
acquiring motion pictures of an apparatus that performs the tridimensional scanning, the apparatus includes markers, wherein acquiring the motion pictures of said apparatus is simultaneous to the tridimensional scanning of said surface.

17. A method according to claim 16, wherein determining the coordinates of the points measured by said tridimensional scanning in said relative frame of reference further comprises:
determining a mathematical transformation correlating a position and an orientation of said relative frame of reference at respective measuring instants, with the position and the orientation of said relative frame of reference at a reference instant of measuring instants;
determining a mathematical transformation that describes a position and an orientation of said apparatus in said absolute frame of reference at each measuring instant; and
determining the coordinates of the points measured by said tridimensional scanning of surfaces in said relative frame of reference based on said mathematical transformations and.

18. A according to claim 14, wherein said surface comprises a thoracic surface.

19. A method for simulating surface deformations, comprising:
applying markers in proximity of a surface or on said surface;
acquiring motion pictures of said markers during predefined movements of said surface; and
determining displacements of said markers for each frame of plural frames acquired by acquiring motion pictures of said markers.

20. A method according to claim 19, further comprising:
determining a tridimensional digital model of said surface by advanced scanning of said surface, the advanced scanning including:
applying markers in proximity of a surface or on the surface;
tridimensionally scanning said surface;
acquiring motion pictures of portions of said surface, wherein acquiring motion pictures is simultaneous to tridimensional scanning said surface;
determining a stationary absolute frame of reference rigidly bound to devices for the acquiring of motion pictures:
determining a relative frame of reference rigidly bound to said surface; and
determining coordinates of points measured by said tridimensional scanning said relative frame of reference;
generating a dynamical model of said surface based on said tridimensional digital model through parameters representing a dynamical behavior of a volume enclosed by said surface; and
applying said displacements of said markers to said dynamical model of said surface for each frame acquired by the acquiring of motion pictures of said markers.

21. A method according to claim 19, wherein said markers are applied in correspondence to anatomical landmarks.

22. A method according to claim 21 wherein said anatomical landmarks are located on a thoracic surface.
